(19) United States
(12) Patent Application Publication
(10) Pub. No.: US 2026/0005007 A1
(43) Pub. Date: Jan. 1, 2026

(54) Sample Analyzer

(71) Applicant: SHIMADZU CORPORATION, Kyoto-shi (JP)

(72) Inventor: Kazuma MAEDA, Kyoto-shi (JP)

(21) Appl. No.: 19/248,271

(22) Filed: Jun. 24, 2025

(30) Foreign Application Priority Data
Jun. 27, 2024 (JP) 2024-103546

(51) Int. Cl. H01J 49/00

(52) U.S. Cl. CPC H01J 49/0009

(57) ABSTRACT

In a sample analyzer in which a device parameter is set for each device component, a storage section holds device-parameter-correlation information prepared based on a measured result obtained by measuring a standard sample under multiple conditions having different values of the device parameter. This information shows the relationship between a device parameter related to a target component included in the device components and the value of an evaluation item in the measured result. The storage section further holds a reference value for the evaluation item. A measured-result acquirer acquires a measured result for the standard sample under a measurement condition including an initial value of the device parameter of the target component. A device-parameter-value determiner calculates the difference between the value of the evaluation item in the measured result and the reference value and determines the value of the device parameter to eliminate the difference based on the device-parameter-correlation information.

### TECHNICAL FIELD

The present invention relates to a sample analyzer such as a mass spectrometer.

### BACKGROUND ART

In order to identify and/or quantify components in samples, various sample analyzers are generally used. In particular, mass spectrometers have been widely used for identifying and/or quantifying trace amounts of components contained in samples since they have high levels of discrimination capability and measurement sensitivity for components.

A mass spectrometer has an ion source, ion transport optical system, mass separator, and ion detector. Predetermined voltages are respectively applied to these devices to ionize components in a sample and detect the resulting ions after separating them according to their mass-to-charge ratios. The value of each of the voltages applied to the related sections of the mass spectrometer during a measurement of a sample is previously determined so that the value of a predetermined evaluation item of a standard sample will reach a reference value, based on the result of a measurement (measurement data) of the standard sample performed using each of a plurality of measurement conditions in which the values of the voltages applied to the aforementioned sections are gradually changed. That the value of a predetermined evaluation item reaches a reference value means, for example, that the half-value width of a mass peak emerging in a mass spectrum obtained from the measurement data falls within a predetermined range, or that the mass-axial shift of the mass spectrum falls within a predetermined range, or that the detection intensity of an ion is not lower than a predetermined value. Mass spectrometers are equipped with a so-called “autotuning” function for automatically performing such a voltage-tuning process in response to a command from an analysis operator (for example, see Patent Literature 1).

### CITATION LIST

### Patent Literature

Patent Literature 1: JP 2018-120804 A

### SUMMARY OF INVENTION

### Technical Problem

In a mass spectrometer, the internal condition of the device gradually changes through the repetition of the measurement of samples. This conditional change affects the measured results. Mass spectrometers may be used for such analyses as the quantification of trace amounts of agricultural chemicals contained in food products or that of trace amounts of metabolites contained in biological samples. For these analyses, high levels of accuracy and reproducibility are required. Therefore, in advance of these types of analyses, the autotuning has conventionally been performed in order to tune the values of the voltages applied to the related sections of the mass spectrometer so that the values of the evaluation items in the measured result will reach their respective reference values.

As described earlier, in the autotuning process, a measurement of a standard sample is performed using each of a plurality of measurement conditions in which the values of the voltages applied to the related components of the mass spectrometer are gradually changed. Therefore, performing the autotuning before every execution of the previously described type of analysis will require a considerable amount of time and lower the operating efficiency.

Although the foregoing description of the problem of the prior art was concerned with the case of a mass spectrometer, a similar problem also occurs with a sample analyzer other than mass spectrometers when determining the values of parameters to be set for the related sections of the device.

The problem to be solved by the present invention is to provide a technique by which the values of parameters to be set for the related sections of a sample analyzer can be efficiently determined.

### Solution to Problem

The present invention developed for solving the previously described problem is a sample analyzer configured to perform an analysis of a sample with a value of a device parameter set for each of a plurality of device components, including:
a storage section which holds device-parameter-correlation information prepared based on a measured result obtained by a measurement of a standard sample using each of a plurality of measurement conditions having different values of the device parameter, the device-parameter-correlation information showing the relationship between the value of a device parameter related to a target component which is one of the plurality of device components and the value of a predetermined evaluation item in the measured result, and the storage section further holding information of a reference value for the predetermined evaluation item;
a measured-result acquirer configured to acquire a measured result by performing a measurement of the standard sample under a measurement condition in which a predetermined initial value is set for the device parameter of the target component; and
a device-parameter-value determiner configured to calculate the difference between the value of the predetermined evaluation item in the measured result acquired by the measured-result acquirer and the reference value and to determine the value of the device parameter of the target component to eliminate the difference based on the device-parameter-correlation information.

### Advantageous Effects of Invention

In the sample analyzer according to the present invention, a measurement of a standard sample is previously performed, using each of a plurality of measurement conditions having different values of a device parameter related to a target component which is one of the device components, to obtain a measured result. Device-parameter-correlation information showing the relationship between the value of the device parameter and the value of a predetermined evaluation item in the measured result is prepared and stored in the storage section. Information of a reference value for the evaluation item is also previously stored in the storage section. In the case where the sample analyzer is a mass spectrometer, examples of the evaluation item include the half-value width of a mass peak emerging in a mass spectrum obtained from measurement data, the mass-axial shift of the mass spectrum, and the detection intensity of an ion. A reference value is set for each of these items. The reference value may be a single specific value such as an upper or lower limit value or it may also be a specific range having both upper and lower limit values.

For example, before an analysis in which high levels of accuracy and reproducibility are required is performed, a measured result is obtained by the measured-result acquirer by performing a measurement of a standard sample under a measurement condition in which a predetermined initial value is set for a device parameter of the target component. The device-parameter-value determiner receives the measured result acquired by the measured-result acquirer and calculates the difference between the value of the predetermined evaluation item in that measured result and the reference value for the same evaluation item and determines the value of the device parameter of the target component for eliminating this difference based on the device-parameter-correlation information. The sample analyzer according to the present invention can efficiently determine the values of device parameters to be set for the device components by a simple process which does not require autotuning and only uses a measured result acquired by a measurement of a standard sample and the device-parameter-correlation information previously stored in the storage section.

### BRIEF DESCRIPTION OF DRAWINGS

FIG. 1 is a configuration diagram of the main components of a mass spectrometer as one embodiment of the sample analyzer according to the present invention.

FIG. 2 is a diagram illustrating the RF gain and the RF offset which are device parameters in the present embodiment.

FIG. 3 is a diagram schematically showing the relationship between the RF gain of the front or rear quadrupole mass filter and the half-value width of the peak in the present embodiment.

FIG. 4 is a diagram schematically showing the relationship between the voltage (amplitude of the radio-frequency voltage) applied to the front or rear quadrupole mass filter and the mass-axial shift in the present embodiment.

FIG. 5 is a diagram schematically showing the relationship between the detector voltage and the detection intensity in the present embodiment.

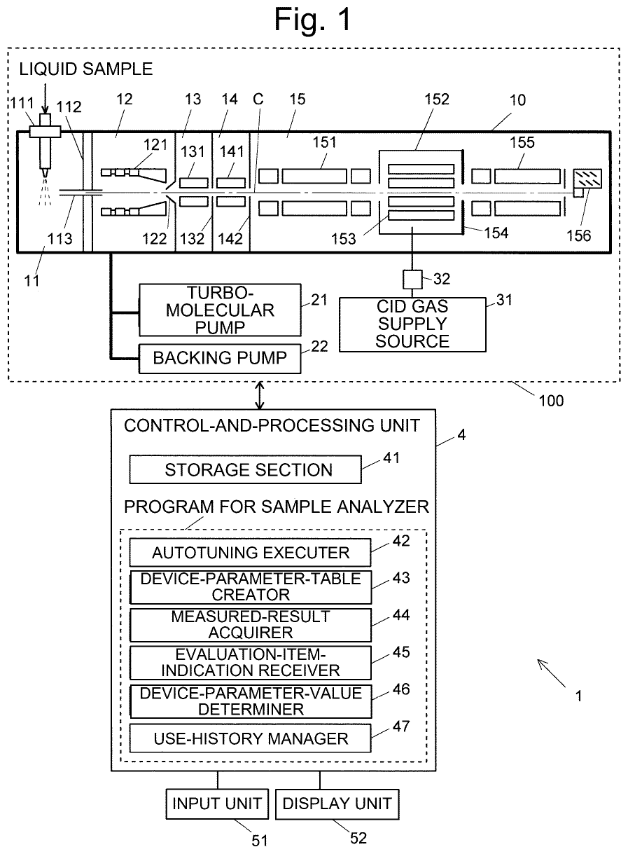

### DESCRIPTION OF EMBODIMENTS

A mass spectrometer 1 as one embodiment of the sample analyzer according to the present invention is hereinafter described with reference to the drawings.

The mass spectrometer 1 has a main unit 100 and a control-and-processing unit 4. The main unit 100 has a cabinet with an ionization chamber 11 provided inside, and a vacuum chamber 10. The vacuum chamber 10 has a first intermediate vacuum chamber 12, second intermediate vacuum chamber 13, third intermediate vacuum chamber 14 and analysis chamber 15 sequentially arranged from the ionization chamber 11. The inner space of the vacuum chamber 10 is evacuated with a turbomolecular pump 21. A backing pump 22 acting as a roughing pump is connected on the exhaust side of the turbomolecular pump 21.

The ionization chamber 11 is provided with an electrospray ion (ESI) source 111 configured to ionize and spray a liquid sample. A partition wall 112 is provided between the ionization chamber 11 and the first intermediate vacuum chamber 12 located in the subsequent stage. A desolvation tube 113 provided in this partition wall 112 allows for the communication between the ionization chamber 11 and the first intermediate vacuum chamber 12.

The first intermediate vacuum chamber 12 contains a first ion guide (Qarray) 121. The first ion guide (Qarray) 121 is configured to receive ions entering the first intermediate vacuum chamber 12 through the desolvation tube 113 and transport those ions to the subsequent stage while converging them into the vicinity of an ion beam axis C (the central axis in the flying direction of the ions). The first intermediate vacuum chamber 12 is separated from the second intermediate vacuum chamber 13 in the subsequent stage by a skimmer 122 having a small hole at its apex.

The second intermediate vacuum chamber 13 contains a second ion guide (multipole 1) 131 consisting of a plurality of rod electrodes. The second ion guide (multipole 1) 131 is configured to receive ions entering the second intermediate vacuum chamber 13 through the small hole formed in the skimmer 122 and transport those ions to the subsequent stage while converging them into the vicinity of the ion beam axis C. Between the second intermediate vacuum chamber 13 and the third intermediate vacuum chamber 14 in the subsequent stage, a first lens electrode (multipole 1 lens) 132 having an opening for allowing ions to pass through is provided. This lens doubles as a partition wall.

The third intermediate vacuum chamber 14 also contains a third ion guide (multipole 2) 141 consisting of a plurality of rod electrodes. The third ion guide (multipole 2) 141 is also configured to receive ions entering the third intermediate vacuum chamber 14 through the opening of the first lens electrode (multipole 1 lens) 132 and transport those ions to the subsequent stage while converging them into the vicinity of the ion beam axis C. Between the third intermediate vacuum chamber 14 and the analysis chamber 15 in the subsequent stage, a second lens electrode (multipole 2 lens) 142 having an opening for allowing ions to pass through is provided. This lens also doubles as a partition wall.

In the analysis chamber 15, a front quadrupole mass filter (Q1) 151, collision cell 152, rear quadrupole mass filter (Q3) 155 and ion detector 156 are sequentially provided from the third intermediate vacuum chamber 14. The front quadrupole mass filter 151 has main rod electrodes as well as pre-rod and post-rod electrodes respectively located before and after the main rod electrodes, respectively. The collision cell 152 contains a multipole ion guide (q2) 153 consisting of eight plate electrodes radially arranged so as to surround the ion beam axis C. A lens electrode 154 is located on the exit-end face of the collision cell 152. A collision-induced dissociation (CID) gas supply source 31 is connected to the collision cell 152, with a flow regulator 32 provided in its passage. The rear quadruple mass filter 155 has pre-rods and main rods. The ion detector 156 in the present embodiment is an electron multiplier tube.

The control-and-processing unit 4 has a storage section 41. The storage section 41 holds a device parameter table for each of the evaluation items concerning mass spectrometric analysis results as well as criterion information concerning each evaluation item. The criterion information specifies the requirement which each evaluation item should satisfy to meet its criterion. For example, when the evaluation item is the half-value width of the peak, the width should not be larger than a predetermined upper limit value. When the evaluation item is the mass-axial shift (the difference between the location at which the mass peak of an ion having a specific mass-to-charge ratio emerges in a mass spectrum and the actual mass-to-charge ratio of that ion), the amount of shift should fall within a predetermined range. When the evaluation item is the detection intensity, the intensity should not be lower than a predetermined lower limit value. The criterion information has initial information previously determined at the time of the shipment or installation of the device. An individual having a specific permission (e.g., an authorized administrator who has logged in to the device with a predetermined ID and password) can change this information.

As noted earlier, the evaluation items concerning mass spectrometric analysis results include the half-value width of the peak, mass-axial shift and detection intensity. A device parameter table is stored for each of these items. A device parameter table represents the relationship between the value of a device parameter related to a voltage applied to an electrode in a related section of the main unit 100 of the mass spectrometer 1 and the value of an evaluation item. This table corresponds to the device-parameter-correlation information in the present invention.

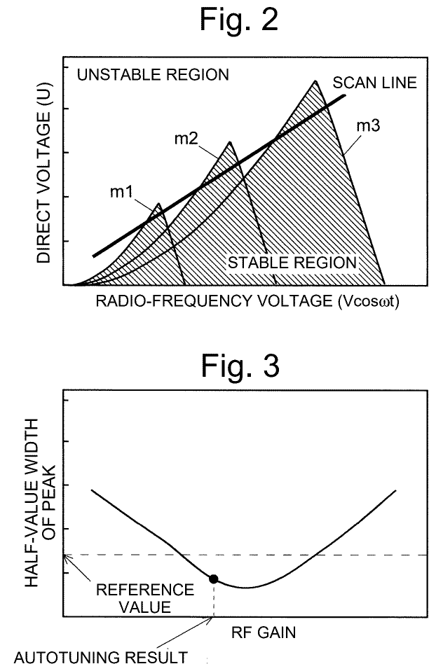

In the present embodiment, the voltages applied to the front and rear quadrupole mass filters 151 and 155 (the values of the RF gain and the RF offset) are set as device parameters for the half-value width of the peak. A device parameter table is prepared for each of these device parameters. FIG. 2 is a stability diagram based on the solutions of Mathieu equations (where m1, m2 and m3 are the masses of ions; m1<m2<m3). The slope of the scan line which represents the relationship between the value of the direct voltage (U) and that of the radio-frequency voltage (V cos ωt) used for a mass scan (or similar operation) corresponds to the RF gain, and the intercept of the same line corresponds to the RF offset. The value of the RF gain depends on both the radio-frequency voltage and the direct voltage applied to the front or rear quadrupole mass filter 151 or 155, while that of the RF offset depends on the value of the direct voltage applied to the front or rear quadrupole mass filter 151 or 155. In a specific type of operation such as the autotuning (which will be described later), the RF gain and the RF offset are set as device parameters for each of the front and rear quadrupole mass filters 151 and 155. When a value is entered into each of these device parameters, the direct voltage and the radio-frequency voltage whose values satisfy the entered values will be applied to the front or rear quadrupole mass filter 151 or 155. It is also possible to relate the RF gain to the RF offset by a predetermined relational expression so that the two parameters can be handled as a single parameter. In that case, only one device parameter table needs to be prepared for each of the front and rear quadrupole mass filters 151 and 155.

Additionally, the voltages (amplitude of the radio-frequency voltage) applied to the front and rear quadrupole mass filters 151 and 155 are also set as device parameters for the mass-axial shift. Furthermore, the lens-system bias voltage, lens-system RF voltage and detector voltage applied to the ion-introducing section are set as device parameters for the detection intensity.

The lens-system bias voltage is specifically a system of direct voltages respectively applied to the second ion guide (multipole 1) 131, first lens electrode (multipole 1 lens) 132, third ion guide (multipole 2) 141, second lens electrode (multipole 2 lens) 142, pre-rod and main rod electrodes of the front quadrupole mass filter 151, and the lens electrode 154 located at the exit end of the collision cell 152. The lens-system RF voltage is a system of radio-frequency voltages respectively applied to the first ion guide (Qarray) 12, second ion guide (multipole 1) 131, third ion guide (multipole 2) 141, and multipole ion guide 153. In the present embodiment, as described earlier, a plurality of device parameters are set for the detection intensity, and one device parameter table is prepared for each of those device parameters.

The ion detector 156 in the present embodiment is an electron multiplier tube. The “detector voltage” mentioned earlier refers to the direct voltage applied to the dynodes in the electron multiplier tube. An electron multiplier tube has voltage regions called the “beginning region”, “knee region”, “plateau region” and “multi-pulse region” in ascending order of the voltage applied to the dynodes. This device can correctly count ion signals when operated within the plateau region. Accordingly, in the device parameter table, voltage values within the plateau region are related to detection intensities.

The control-and-processing unit 4 includes, as its functional blocks, an autotuning executer 42, device-parameter-table creator 43, measured-result acquirer 44, evaluation-item-indication receiver 45, device-parameter-value determiner 46, and use-history manager 47. The control-and-processing unit 4 is actually a common type of personal computer, with those functional blocks embodied by executing pre-installed software (a program for the sample analyzer) on the processor. Additionally, an input unit 51 consisting of a keyboard and a mouse (or the likes), as well as a display unit 52 consisting of a liquid crystal display (or the like), are connected to the control-and-processing unit 4.

Next, an operation of the mass spectrometer 1 according to the present embodiment is described.

At the time of the shipment or installation of the mass spectrometer 1, a plurality of measurement conditions are set in which each of the voltages applied to the related components of the mass spectrometer is individually varied over a specific scan range, and a mass spectrometric analysis of a standard sample is performed using each of those measurement conditions. The applied voltages to be varied for the scan include the previously described device parameters related to the evaluation items concerning mass spectrometric analysis results.

A user (which includes an individual in charge of the shipment or installation of the device) issues a command to perform the autotuning. Then, based on the initial measurement condition in which previously determined initial values are set as the voltages applied to the electrodes in the related components of the mass spectrometer, the autotuning executer 42 sets a plurality of measurement conditions in which the value of one previously designated device parameter (“device parameter A”) is varied over a previously determined scan range (in which a plurality of values are set at predetermined intervals). Using each of those measurement conditions, the autotuning executer 42 conducts a measurement of a predetermined standard sample. As regards the standard sample, a sample in which a compound that generates an ion having a previously determined mass-to-charge ratio is contained in a predetermined quantity (or at a predetermined concentration) is used. The measurement data acquired under each measurement condition is related to that measurement condition and saved in the storage section 41.

After the previously described measurement has been completed, the autotuning executer 42 reads, from the storage section 41, the criterion information set for each of the evaluation items, i.e., the half-value width of the peak, mass-axial shift and detection intensity, locates a measurement condition which meets the requirements of the criterion information of all evaluation items (or a measurement condition which is the closest to that condition), and adopts the value of device parameter A included in the located measurement condition as the autotuning result for device parameter A. Furthermore, when device parameter A corresponds to a device parameter related to an evaluation item concerning mass spectrometric analysis results, the device-parameter-table creator 43 creates a device parameter table showing the relationship between the value of device parameter A and the value of the evaluation item related to that device parameter and saves the table in the storage section 41.

Subsequently, based on the measurement condition in which the value of device parameter A has been changed from the value in the initial measurement condition to the value adopted as the autotuning result, the autotuning executer 42 sets a plurality of measurement conditions in which the value of one device parameter (“device parameter B”) previously designated as the device parameter to be tuned next to device parameter A is varied over a previously determined scan range. Then, the autotuning executer 42 conducts a measurement of the same standard sample using each of those measurement conditions. The measurement data acquired under each measurement condition is related to that measurement condition and saved in the storage section 41.

After the completion of the measurement, the autotuning executer 42 locates a measurement condition which satisfies the criterion information of all evaluation items (or a measurement condition which is the closest to that condition), and determines the value of device parameter B in the located measurement condition as the autotuning result for device parameter B. Furthermore, when device parameter B corresponds to a device parameter related to an evaluation item concerning mass spectrometric analysis results, the device-parameter-table creator 43 creates a device parameter table showing the relationship between the value of device parameter B and the value of the evaluation item related to that device parameter and saves the table in the storage section 41.

In the previously described manner, the scan of values is performed for each of the plurality of device parameters in a previously determined order and one value as the autotuning result is determined for each of those device parameters. The autotuning is discontinued when the values as the autotuning results have been determined for all device parameters.

FIGS. 3-5 schematically show, in the form of graphs, the relationship between a device parameter and a related evaluation item described in the device parameter tables created through the autotuning. It should be noted that the relationships shown in FIGS. 3-5 are mere examples for the following descriptions. The relationship between an increase/decrease in the value of an evaluation item and an increase/decrease in the value of a related device parameter varies depending on each individual mass spectrometer.

FIG. 3 schematically shows the relationship between the RF gain of the front or rear quadrupole mass filter 151 or 155 (device parameter) and the half-value width of the peak (evaluation item). As shown in FIG. 3, a value of the RF gain at which the half-value width of the peak is not larger than a predetermined reference value (upper limit value) is determined as the autotuning result for the half-value width of the peak. It should be noted that the value which yields the smallest value of the half-value width of the peak is not adopted as the autotuning result in the present example. This is due to the fact that decreasing the half-value width of the peak lowers the detection intensity, and the requirement specified in the criterion information of the detection intensity cannot be satisfied if the value of the device parameter that yields the smallest half-value width of the peak is used. The same holds true for the other evaluation items; the best value for one evaluation item is not always adopted as the autotuning result. Additionally, a device parameter table describing a similar relationship with respect to the RF offset is also created for the half-value width of the peak.

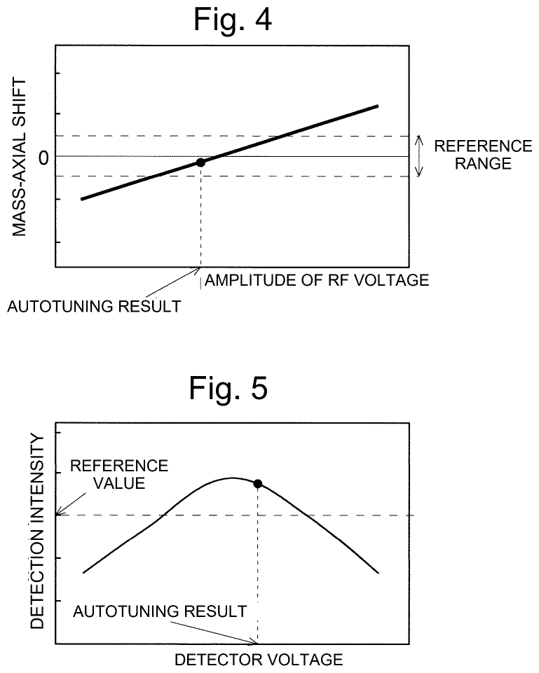

FIG. 4 schematically shows the relationship between the amplitude of the radio-frequency voltage applied to the front or rear quadrupole mass filter 151 or 155 (device parameter) and the mass-axial shift (evaluation item). As shown in FIG. 4, a value of the voltage (amplitude of the radio-frequency voltage) applied to the rear quadrupole mass filter (Q3) 155 at which the mass-axial shift falls within a predetermined reference range is determined as the autotuning result for the mass-axial shift.

FIG. 5 schematically shows the relationship between the detector voltage (device parameter) and the detection intensity (evaluation item). As shown in FIG. 5, a value of the detector voltage at which the detection intensity is not lower than a predetermined reference value (lower limit value) is determined as the autotuning result for the detection intensity. Additionally, device parameter tables describing similar relationships with respect to the lens-system bias voltage and the lens-system RF voltage (applied to the individual electrodes described earlier) are also created for the detection intensity.

After the completion of the autotuning process, the use-history manager 47 records the date and time of the autotuning and begins recording the elapsed time from that point in time (the elapsed time measured whether or not the device is in use) as well as the history of mass spectrometric analyses performed after the autotuning (e.g., the number of times of use and the total time of use). These pieces of information are sequentially saved in the storage section 41.

When the user is going to conduct an analysis in which high levels of accuracy and reproducibility are required as in the case of the quantitative determination of trace amounts of agricultural chemicals contained in food products or that of trace amounts of metabolites contained in biological samples, the tuning of the device parameters should be performed beforehand. This tuning process is hereinafter described.

The user performs a predetermined input operation for issuing a command to initiate the tuning of device parameters. Then, the measured-result acquirer 44 prompts the user to set the previously determined standard sample (which is the same as the standard sample used in the autotuning or other processes for creating the device parameter tables) in the mass spectrometer.

After setting the standard sample, the user issues a command to initiate the measurement. The measured-result acquirer 44 sets the values of the device parameters as determined in the autotuning and performs the measurement. From the measured result, the measured-result acquirer 44 calculates the value of each evaluation item and shows the result on the screen of the display unit 52. The criterion information of the evaluation items stored in the storage section 41 is also shown on the same screen.

The evaluation-item-indication receiver 45 shows, on the display unit 52, a screen for receiving an input for indicating one of the evaluation items (in the present embodiment, the half-value width of the peak, mass-axial shift and detection intensity) for which device parameters are stored in the storage section 41.

In general, the condition of a mass spectrometer gradually changes through the repetitive use of the device. Therefore, even when a measurement in which the values of the device parameters are set as determined in the autotuning is performed for the same standard sample, the measured result will be slightly different from the result obtained at the time of the autotuning. Accordingly, the values of the evaluation items determined by the measured-result acquirer 44 at this point in time are not identical to but slightly different from the values obtained at the time of the autotuning.

Accordingly, the user checks the value of each evaluation item at that point in time on the screen of the display unit 52, selects an evaluation item which the user considers needs to be tuned (since its value does not meet the requirement specified in the criterion information), and changes the value of that evaluation item by tuning the device parameter related to that evaluation item.

When the user has performed an input operation for indicating one of the evaluation items, the device-parameter-value determiner 46 shows the device parameters related to the indicated evaluation item on the screen of the display unit 52. For example, if the half-value width of the peak has been selected, the four device parameters related to that evaluation item are shown as options, i.e., the RF gain and the RF offset for each of the front and rear quadruple mass filters 151 and 155.

When the user has selected one of those device parameters, the device-parameter-value determiner 46 compares the current value of the indicated evaluation item with the criterion information, calculates the amount of tuning necessary for satisfying the requirement for that criterion, and changes the value of that device parameter so that the value of the evaluation item in question changes by the calculated amount of tuning.

For example, as shown in FIG. 3, the device parameter table containing information which describes the relationship between the value of the RF gain and the half-value width of the peak shows that increasing the RF gain from the value determined at the time of the autotuning decreases the half-value width of the peak. Accordingly, when the half-value width of the peak is larger than the lower limit value specified in the criterion information, the device-parameter-value determiner 46 performs the tuning for increasing the value of the RF gain so that the half-value width of the peak becomes smaller by an amount corresponding to the aforementioned amount of tuning. The present example is concerned with the case where the user has selected the value of the RF gain of the front or rear quadrupole mass filter 151 or 155 as the device parameter to be tuned. A similar tuning process will also be performed in the case where the RF offset has been selected.

As another example, as shown in FIG. 4, the device parameter table containing information which describes the relationship between the value of the mass-axial shift and that of the volage (radio-frequency voltage) applied to the front or rear quadrupole mass filter 151 or 155 shows that increasing the applied voltage from the value determined at the time of the autotuning increases the value of the mass-axial shift. It should be noted that an “increase” in the value of the mass-axial shift in the present context means a change in the value of the axial shift in the positive direction (for example, this includes the case where the absolute value of the mass-axial shift decreases, as in the case where the mass-axial shift changes from −0.5 to −0.1 with an increase in the value of the applied voltage). Accordingly, the device-parameter-value determiner 46 increases or decreases the value of the voltage (radio-frequency voltage) applied to the front or rear quadrupole mass filter 151 or 155 so that the value of the mass-axial shift falls within the predetermined range.

Consider yet another example in which the detection intensity is lower than the value specified in the criterion information. As shown in FIG. 5, the device parameter table containing information which describes the relationship between the detection intensity and the detector voltage shows that decreasing the detector voltage from the value determined at the time of the autotuning increases the detection intensity. Accordingly, the device-parameter-value determiner 46 performs the tuning for decreasing the value of the detector voltage so that the detection intensity increases by an amount corresponding to the aforementioned amount of tuning. The present example is concerned with the case where the user has selected the value of the detector voltage as the device parameter to be tuned. A similar tuning process will also be performed in the case where one of the lens-system bias and lens-system RF voltages has been selected.

With the tuning of the values of the device parameters thus completed, the measured-result acquirer 44 changes the values of the device parameters to the tuned values and once more performs the measurement of the same standard sample. From the measured result, the measured-result acquirer 44 calculates the value of each evaluation item and shows the result on the screen of the display unit 52. The criterion information of the evaluation items stored in the storage section 41 is also shown on the same screen.

After confirming that the values of all evaluation items in the measured result acquired under the tuned measurement condition meet the requirements specified in the criterion information, the user performs the measurement of a target sample.

If there is an evaluation item whose value does not meet the requirement specified in the criterion information, all device parameters should be tested to determine whether or not the tuning is possible. Specifically, if there are a plurality of device parameters related to the evaluation item concerned, the previously described process of tuning of a device-parameter value is similarly attempted for an untuned device parameter. Subsequently, the measurement of the standard sample is once more performed in the previously described manner, and it is determined whether or not the values of the evaluation items in the measured result meet the requirements specified in the criterion information.

When there is only a single device parameter related to the evaluation item in question (this is not the case with the present embodiment, but such a case can also fall within the scope of the present invention) or when the requirements specified in the criterion information cannot be met even by the tuning of the other device parameters, the autotuning is once more performed.

The description thus far has been concerned with the example in which the user performs the tuning of the device parameters before the execution of an analysis in which high levels of accuracy and reproducibility are required. The screen for prompting the user to perform the tuning of the device parameters is also shown on the screen of the display unit 52 when the use-history manager 47 has determined that the history of use of the mass spectrometer has reached a previously determined condition (e.g., when a predetermined period of time has passed since the last autotuning, or when mass spectrometric analyses have been performed a predetermined number of times since the last autotuning, or when the total time of use of the mass spectrometer has reached a predetermined amount of time since the last autotuning). The tuning of the values of the device parameters is also similarly performed when this screen has been shown.

Conventionally, when an analysis in which high levels of accuracy and reproducibility are required is going to be performed, the autotuning is always performed regardless of the history of use of the mass spectrometer after the last autotuning. In the autotuning, many measurement conditions in which the values of a plurality of device parameters are individually and gradually changed are set, and a measurement of the standard sample is performed using each of those many measurement conditions. Therefore, a considerable period of time is required for the autotuning.

Although the condition of a mass spectrometer gradually changes through the repetitive use of the device, the change per one time of use is normally insignificant and does not cause a sudden change in the condition of the device. Therefore, the relationship between the value of an evaluation item and the value of a device parameter at the time of the autotuning does not significantly change, and this information can be effectively used for the fine-tuning of the device parameter. In the present embodiment, due to the use of this information, the autotuning can be omitted and the values of the device parameters can be quickly and efficiently tuned so that each evaluation item will meet a predetermined requirement.

The previously described embodiment is a mere example and can be appropriately changed or modified without departing from the spirit of the present invention.

Although the previous description of the embodiment was concerned with a triple quadrupole mass spectrometer, a similar configuration to the previous embodiment can also be adopted for various types of mass spectrometers such as a single quadrupole type, ion trap type or time-of-flight type of mass spectrometer. The values of device parameters in various analyzers other than mass spectrometers (e.g., chromatographs or spectrophotometers) can also be quickly and efficiently determined in a similar manner to the previous embodiment by appropriately determining the relationship between an evaluation item and a device parameter.

The evaluation items and the device parameters in the previous embodiment are also mere examples. A tuning process similar to the previous embodiment for evaluation items other than those described in the previous embodiment can also be performed by relating appropriate device parameters to those evaluation items. Examples of such evaluation items include the signal-to-noise (S/N) ratio and the shape (e.g., symmetry) of the mass peak.

In the previous embodiment, the user was allowed to indicate evaluation items that need to be tuned. It is also possible to configure the evaluation-item-indication receiver 45 to automatically designate evaluation items that need to be tuned by determining whether or not the value of each evaluation item in the result of the measurement of the standard sample meets the requirement of the criterion information stored in the storage section 41. In that case, the order of priority for the execution of the tuning of device parameters may be previously determined for an evaluation item to which a plurality of device parameters are related, and the device-parameter-value determiner 46 may be configured to perform the tuning of the values of the device parameters in order of priority until the result of the measurement of the standard sample meets the requirements specified in the criterion information. Additionally, when the result of the measurement of the standard sample does not meet the requirements specified in the criterion information even after the values of all device parameters have been tuned, the autotuning executer 42 may automatically perform the autotuning, and the device-parameter-table creator 43 may create new device parameter tables.

In the previously described embodiment, the device parameter tables were created during the execution of the autotuning. However, the device parameter tables may also be created at any appropriate time other than the autotuning.

In the previously described embodiment, the relationship between the value of a device parameter related to a voltage applied to an electrode in a related section of the main unit 100 of the mass spectrometer 1 and the value of an evaluation item was represented by a device parameter table and stored in the storage section 41. The information to be stored does not always need to be in a tabular form but may also be in other forms such as a mathematical expression.

### Modes

It is evident to a person skilled in the art that the previously described illustrative embodiment is a specific example of the following modes of the present invention.

### Clause 1

One mode of present invention is a sample analyzer configured to perform an analysis of a sample with a value of a device parameter set for each of a plurality of device components, including:
a storage section which holds device-parameter-correlation information prepared based on a measured result obtained by a measurement of a standard sample using each of a plurality of measurement conditions having different values of the device parameter, the device-parameter-correlation information showing the relationship between the value of a device parameter related to a target component which is one of the plurality of device components and the value of a predetermined evaluation item in the measured result, and the storage section further holding information of a reference value for the predetermined evaluation item;
a measured-result acquirer configured to acquire a measured result by performing a measurement of the standard sample under a measurement condition in which a predetermined initial value is set for the device parameter of the target component; and
a device-parameter-value determiner configured to calculate the difference between the value of the predetermined evaluation item in the measured result acquired by the measured-result acquirer and the reference value and to determine the value of the device parameter of the target component to eliminate the difference based on the device-parameter-correlation information.

In the sample analyzer according to Clause 1, a measurement of a standard sample is previously performed, using each of a plurality of measurement conditions having different values of a device parameter related to a target component which is one of the device components, to obtain a measured result. Device-parameter-correlation information showing the relationship between the value of the device parameter and the value of a predetermined evaluation item in the measured result is prepared and stored in the storage section. Information of a reference value for the evaluation item is also previously stored in the storage section. In the case where the sample analyzer is a mass spectrometer, examples of the evaluation item include the half-value width of a mass peak emerging in a mass spectrum obtained from measurement data, the mass-axial shift of the mass spectrum, and the detection intensity of an ion. A reference value is set for each of these items. The reference value may be a single specific value such as an upper or lower limit value or it may also be a specific range having both upper and lower limit values.

For example, before an analysis in which high levels of accuracy and reproducibility are required is performed, a measured result is obtained by the measured-result acquirer by performing a measurement of the standard sample under a measurement condition in which a predetermined initial value is set for a device parameter of the target component. The device-parameter-value determiner receives the measured result acquired by the measured-result acquirer and calculates the difference between the value of the predetermined evaluation item in that measured result and the reference value for the same evaluation item and determines the value of the device parameter of the target component for eliminating this difference based on the device-parameter-correlation information. The sample analyzer according to Clause 1 can efficiently tune the values of device parameters to be set for the related sections of the device by a simple process which does not require autotuning and only uses a measured result acquired by a measurement of a standard sample and the device-parameter-correlation information previously stored in the storage section.

### Clause 2

In the sample analyzer according to Clause 2, which is a sample analyzer according to Clause 1,
the storage section further holds information concerning a use criterion for the sample analyzer,
the sample analyzer further includes a use-history manager configured to manage the history of use of the sample analyzer, and
the measured-result acquirer is configured to output information for prompting a user to perform a measurement of the standard sample, based on the fact that the history of use of the sample analyzer managed by the use-history manager reached the use criterion.

### Clause 3

In the sample analyzer according to Clause 3, which is a sample analyzer according to Clause 2, the use criterion is at least one of the following: the elapsed time after the last tuning of the value of the device parameter, the number of times of use after the last tuning of the value of the device parameter, and the total time of use after the last tuning of the value of the device parameter.

In the sample analyzer according to Clause 2, the history of use of the sample analyzer is managed by the use-history manager. When the history of use of the sample analyzer (after the last tuning) has reached the use criterion, the measured-result acquirer prompts the user to perform a measurement of a standard sample. After the measurement of the standard sample, the device-parameter-value determiner automatically determines the value of the device parameter. Therefore, the value of the device parameter can be tuned before the condition of the sample analyzer significantly changes. The use criterion for the sample analyzer may be specified according to Clause 3; i.e., it may be at least one of the following: the elapsed time after the last tuning of the value of the device parameter (the elapsed time measured whether or not the device is in use), the number of times of use after the last tuning of the value of the device parameter, and the total time of use after the last tuning of the value of the device parameter.

### Clause 4

In the sample analyzer according to Clause 4, which is a sample analyzer according to one of Clauses 1-3,
the storage section holds device-parameter-correlation information and information of a reference value for each of a plurality of the predetermined evaluation items, and
the device-parameter-value determiner is configured to change the value of the device parameter of the target component related to an evaluation item among the plurality of evaluation items if the value of that evaluation item in the measured result does not meet the requirement of the reference value.

The sample analyzer according to Clause 4 can efficiently change the value of the device parameter of a target component related to an evaluation item among a plurality of evaluation items if the value of that evaluation item in the measured result does not meet the requirement of the reference value, and the tuning of the device parameters can be performed so that all evaluation items meet the requirements of their respective reference values.

### Clause 5

In the sample analyzer according to Clause 5, which is a sample analyzer according to one of Clauses 1-4, the sample analyzer is a mass spectrometer configured to perform a mass spectrometric analysis of an ion generated from a sample.

### Clause 6

In the sample analyzer according to Clause 6, which is a sample analyzer according to Clause 5, the predetermined evaluation item is at least one of the following: the half-value width of a mass peak, the mass-axial shift and the detection intensity.

Mass spectrometers have often been used for identifying and/or quantifying trace amounts of components contained in samples since they have high levels of discrimination capability and measurement sensitivity for components. Before the execution of this type of measurement, autotuning is often performed. Therefore, the configuration of the mass analyzer according to any one of Clauses 1-4 can be suitably applied in mass spectrometers. Examples of the representative evaluation items in a mass spectrometer include the half-value width of a mass peak, the mass-axial shift and the detection intensity.

### REFERENCE SIGNS LIST

1 . . . Mass Spectrometer
10 . . . Vacuum Chamber
100 . . . Main Unit
11 . . . Ionization Chamber
111 . . . Electrospray Ion Source
112 . . . Partition Wall
113 . . . Desolvation Tube
12 . . . First Intermediate Vacuum Chamber
121 . . . First Ion Guide
122 . . . Skimmer
13 . . . Second Intermediate Vacuum Chamber
131 . . . Second Ion Guide
14 . . . Third Intermediate Vacuum Chamber
141 . . . Third Ion Guide
15 . . . Analysis Chamber
151 . . . Front Quadrupole Mass Filter
152 . . . Collision Cell
153 . . . Multipole Ion Guide
154 . . . Lens Electrode
155 . . . Rear Quadrupole Mass Filter
156 . . . Ion Detector
21 . . . Turbomolecular Pump
22 . . . Backing Pump
31 . . . Collision-Induced Dissociation (CID) Gas Supply Source
32 . . . Flow Regulator
4 . . . Control-and-Processing Unit
41 . . . Storage Section
42 . . . Autotuning Executer
43 . . . Device-parameter-table creator
44 . . . Measured-Result Acquirer
45 . . . Evaluation-Item-Indication Receiver
46 . . . Device-Parameter-Value Determiner
47 . . . Use-History Manager
51 . . . Input Unit
52 . . . Display Unit

1. A sample analyzer configured to perform an analysis of a sample with a value of a device parameter set for each of a plurality of device components, comprising:
a storage section which holds device-parameter-correlation information prepared based on a measured result obtained by a measurement of a standard sample using each of a plurality of measurement conditions having different values of the device parameter, the device-parameter-correlation information showing a relationship between a value of a device parameter related to a target component which is one of the plurality of device components and a value of a predetermined evaluation item in the measured result, and the storage section further holding information of a reference value for the predetermined evaluation item;
a measured-result acquirer configured to acquire a measured result by performing a measurement of the standard sample under a measurement condition in which a predetermined initial value is set for the device parameter of the target component; and
a device-parameter-value determiner configured to calculate a difference between the value of the predetermined evaluation item in the measured result acquired by the measured-result acquirer and the reference value and to determine a value of the device parameter of the target component to eliminate the difference based on the device-parameter-correlation information.

2. The sample analyzer according to claim 1, wherein:
the storage section further holds information concerning a use criterion for the sample analyzer;
the sample analyzer further comprises a use-history manager configured to manage a history of use of the sample analyzer; and
the measured-result acquirer is configured to output information for prompting a user to perform a measurement of the standard sample, based on a fact that the history of use of the sample analyzer managed by the use-history manager reached the use criterion.

3. The sample analyzer according to claim 2, wherein the use criterion is at least one of following: an elapsed time after a last tuning of the value of the device parameter, a number of times of use after the last tuning of the value of the device parameter, and a total time of use after the last tuning of the value of the device parameter.

4. The sample analyzer according to claim 1, wherein:
the storage section holds device-parameter-correlation information and information of a reference value for each of a plurality of the predetermined evaluation items, and
the device-parameter-value determiner is configured to change the value of the device parameter of the target component related to an evaluation item among the plurality of evaluation items if the value of that evaluation item in the measured result does not meet a requirement of the reference value.

5. The sample analyzer according to claim 1, which is a mass spectrometer configured to perform a mass spectrometric analysis of an ion generated from a sample.

6. The sample analyzer according to claim 5, wherein the predetermined evaluation item is at least one of following: a half-value width of a mass peak, a mass-axial shift and a detection intensity.
